(19) United States
(12) Patent Application Publication
(10) Pub. No.: US 2015/0062559 A1
(43) Pub. Date: Mar. 5, 2015

(54) HANDHELD TACHOMETER

(71) Applicant: Soongsil University Research Consortium Techno-Park, Seoul (KR)

(72) Inventors: Jin Oh Kim, Seoul (KR); Chunguang Piao, Seoul (KR)

(21) Appl. No.: 14/475,865

(22) Filed: Sep. 3, 2014

(30) Foreign Application Priority Data
Sep. 4, 2013 (KR) 10-2013-0106151

(51) Int. Cl. G01P 3/36; G01J 1/04

(52) U.S. Cl. CPC G01P 3/36; G01J 1/0407
USPC 356/28

(57) ABSTRACT

A handheld tachometer includes a body that controls light output, and calculates a rotational velocity of an object based on incident light reflected from the object, and a reflector that is positioned at a light output terminal of the body, to adjust an angle of output light or incident light. The reflector can be adjusted by driving a step motor. The body may also have a motor control interface for a user to adjust the driving direction and degree of the step motor.

### CROSS-REFERENCE TO RELATED APPLICATION

This application claims the benefit of Korea Patent Application No. 10-2013-0106151 filed on Sep. 4, 2013, the disclosure of which are incorporated herein by reference.

### TECHNICAL FIELD

The embodiments described herein pertain generally to a handheld tachometer capable of easily measuring a rotational velocity of a rotating object.

### BACKGROUND

Generally known tachometers shoot a laser at a rotating object and measures the laser reflected from the rotating object to calculate a rotational velocity of the rotating object based on the measurement.

The tachometer is utilized for devices whose axial rotation is important, such as an engine, a motor and a generator.

Handheld tachometers are configured to have a size small enough to be carried in one hand such that a user can measure a rotational velocity of an object while moving, and thus, improve convenience.

However, even when a handheld tachometer is used, there is the inconvenience that when the location of an object changes, location of the tachometer needs to be identified again to be used. Meanwhile, the same problem may also exist in an optical instrument, which outputs light and measures various parameters for an object by using incident light to be reflected and incident from the object, in addition to the handheld tachometer.

Japanese Patent Application Publication No. 2005-291850 (“Tachometer”) describes a tachometer, which includes a sensor sensing rotational movement of an object to be measured and outputting a signal accompanying a quantity of the rotational movement, a controller including a calculating means, which calculates the signal input from the sensor as certain measurement data, a memory storing the measurement data, and a display displaying the measurement data.

### SUMMARY

In view of the foregoing, example embodiments provide a configuration capable of easily adjusting a light path of output light or incident light through a reflector connected to a handheld tachometer.

In one example embodiment, there is provided a handheld tachometer. The handheld tachometer includes a body that controls light output, and calculates a velocity of an object based on incident light reflected from the object, and a reflector that is positioned at a light output terminal of the body, to adjust an angle of output light or incident light.

In another example embodiment, there is provided an optical instrument. The optical instrument includes a body that controls light output, and calculates a velocity of an object based on incident light reflected from the object, and a reflector that is positioned at a light output terminal of the body, to adjust an angle of output light or incident light.

In accordance with the example embodiments, a reflector is provided in a handheld tachometer or an output terminal of various optical instruments, whereby angles of output light and incident light can be easily adjusted. In this way, physical quantities, including a rotational velocity with respect to objects existing in different locations, can be measured only through adjustment of an angle of the reflector. This is possible even in the state that the location of the handheld tachometer or the optical instruments is fixed.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

In the detailed description that follows, embodiments are described as illustrations only since various changes and modifications will become apparent to those skilled in the art from the following detailed description. The use of the same reference numbers in different figures indicates similar or identical items.

FIG. 1 shows a handheld tachometer in accordance with an example embodiment.

FIG. 2 depicts a concept of adjustment of an angle of a reflector in accordance with an example embodiment.

FIG. 3 shows a handheld tachometer in accordance with another example embodiment.

FIG. 4 shows configuration of a reflector of a handheld tachometer in accordance with another example embodiment.

### DETAILED DESCRIPTION

Hereinafter, example embodiments will be described in detail with reference to the accompanying drawings so that the inventive concept may be readily implemented by those skilled in the art. However, it is to be noted that the present disclosure is not limited to the example embodiments but can be realized in various other ways. In the drawings, certain parts not directly relevant to the description are omitted to enhance the clarity of the drawings, and like reference numerals denote like parts throughout the whole document.

Throughout the whole document, the terms “connected to” or “coupled to” are used to designate a connection or coupling of one element to another element and include both a case where an element is “directly connected or coupled to” another element and a case where an element is “electronically connected or coupled to” another element via still another element. In addition, the term “comprises or includes” and/or “comprising or including” used in the document means that one or more other components, steps, operations, and/or the existence or addition of elements are not excluded in addition to the described components, steps, operations and/or elements.

For convenience in description, example embodiments will be described based on a handheld tachometer, but the essential principle of example embodiments may be sufficiently applied to various types of optical instruments, which output light to an object, and measures various physical quantities of the object based on light incident after the output light is reflected from the object.

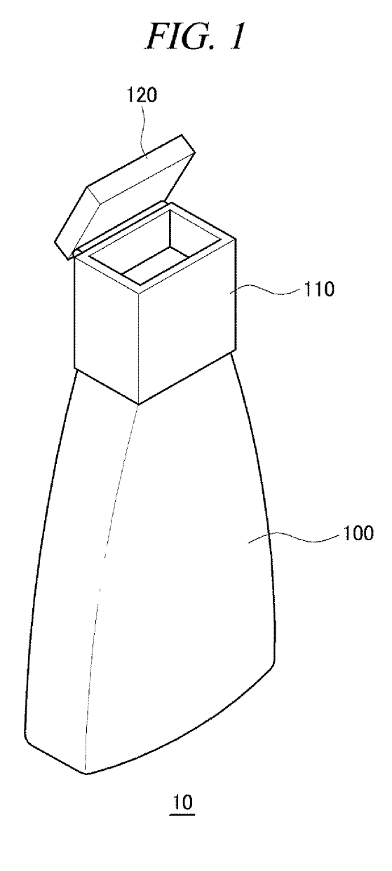

FIG. 1 shows a handheld tachometer in accordance with an example embodiment. The handheld tachometer 10 includes a body 100, a light guide portion 110 and a reflector 120. The body 100 includes a control module (not illustrated), which controls light output to calculate a velocity of an object based on incident light reflected from the object. In addition, the body 100 may further include a configuration of a light output device, a light sensing device or a power suppl. In addition, the body 100 includes a housing, which contains the control module and can be easily grasped by a user. A shape of the housing may variously change so as to be easily grasped by a user.

The light guide portion 110 guides the heading of output light or incident light and is connected to a light output terminal of the body 100. For example, the light guide portion 110 may guide light output from the light output device by a certain length, or light incident from the outside to the light sensing device. As illustrated, the light guide portion 100 may have a square pillar shape having a certain length, and may be transformed in various shapes such as a cylindrical shape.

The reflector 120 is positioned at the light output terminal of the body 100, to adjust an angle of output light or incident light. The reflector 120 may be hinge-connected to one side of the light output terminal of the body 100 or one side of the light guide portion 110, such that a connection angle between the reflector 120 and the body 100 or between the reflector 120 and the light guide portion 110 can be adjusted. As the connection angle is adjusted, the reflector 120 may completely cover or open an opening of the light output terminal or an opening of the light guide portion 110. When the reflector 120 completely covers the opening, various foreign materials such as water and dust can be prevented from being penetrated into the body 100. In addition, the connection angle between the reflector 120 and the light guide portion 110 can be 90° or more, such that the opening is completely opened, and output light and incident light directly exit or are directly incident without passing through the reflector 120.

The reflector 120 may be configured by using various types of reflection materials such as a mirror or a metal material. Further, the reflector 120 may be provided with a support that supports the reflector 120, whereby the reflector 120 is connected to or stacked on the support, and the support may be connected to the body 100 or the light guide portion 110.

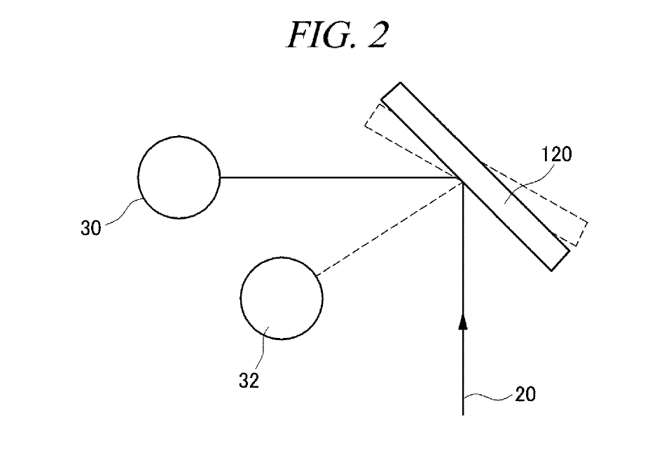

FIG. 2 depicts a concept of adjustment of an angle of the reflector in accordance with an example embodiment. As illustrated, when rotational velocities of different objects 30, 32 are measured in the state that the handheld tachometer 10 is fixed, light for each of the objects 30, 32 is output by adjusting an angle of the reflector 120, and light reflected and incident from each of the objects 30, 32 can be sensed. Accordingly, rotational velocities of different objects can be conveniently measured.

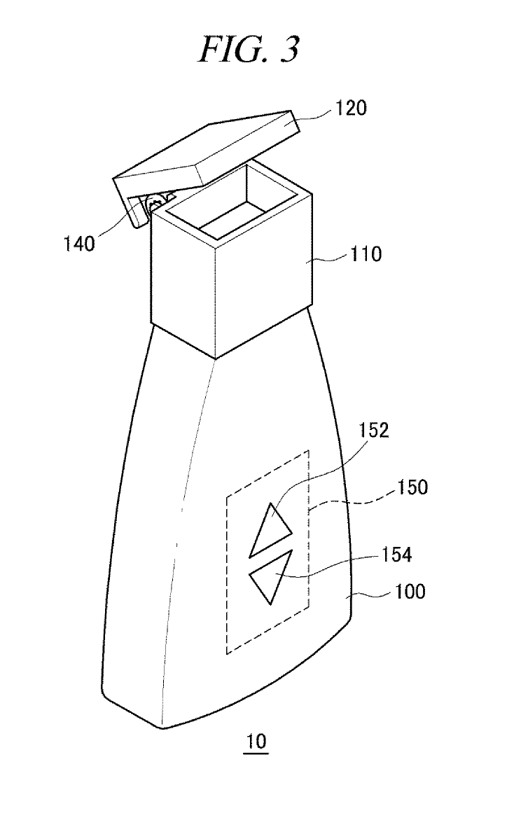

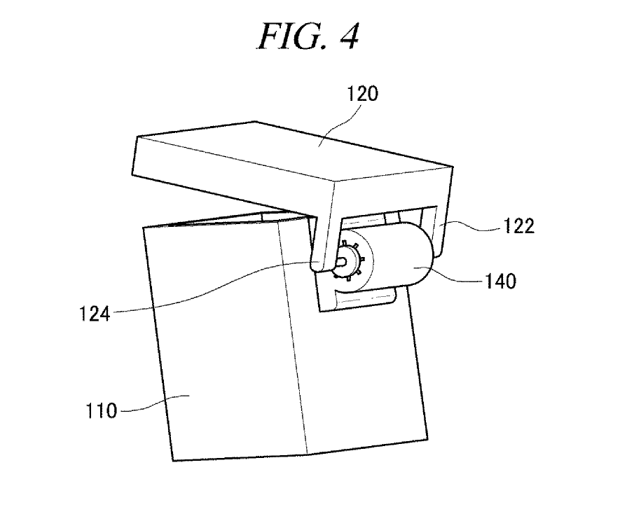

FIG. 3 shows a handheld tachometer in accordance with another example embodiment, and FIG. 4 shows a configuration of a reflector of a handheld tachometer in accordance with another example embodiment.

The illustrated handheld tachometer 10 further includes a step motor 140 for adjustment of an angle of the reflector 120, and a motor control interface 150 for driving of the step motor 140 in the body 100.

As illustrated in FIG. 4, the step motor 140 is fixed to one side surface of the light guide portion 110, and a driving shaft of the step motor 140 is inserted into a fixture groove formed in fixing portions 122, 124 of the reflector 120, such that an angle of the reflector 120 is adjusted according to the driving of the step motor 140.

The angle adjustment state of the reflector 120 may be adjusted as a driving direction and a driving degree of the step motor 140 are adjusted. In addition, when the driving of the step motor 140 is stopped, the state of the reflector 120 at the time that the step motor 140 is stopped is held, so that the angle of the reflector 120 is fixed at a certain angle.

A user may control the driving direction and degree of the step motor 140 through the motor control interface 150. For example, when an upper button 152 is operated, the reflector 120 moves toward an upper side such that the angle between the reflector 120 and the light guide portion 110 is controlled to increase. When a lower button 154 is operated, the reflector 120 moves toward a lower side such that the angle between the reflector 120 and the light guide portion 110 is controlled to be reduced.

The motor control interface 150 transmits various control signals to a step motor driving controller equipped in the body 100 to control the driving state of the step motor 140. In this case, the motor control interface 150 may be positioned on one surface of the body 100, and have a physical button form configuration. However, the motor control interface 150 may be configured to be in a virtual interface form displayed on a plane display such as a touch screen.

According to the foregoing configuration, a user can easily adjust the angle of the reflector connected to a handheld tachometer or various light instruments, and as a result, easily adjust the output state of reflected light.

The above description of the example embodiments is provided for the purpose of illustration, and it would be understood by those skilled in the art that various changes and modifications may be made without changing technical conception and essential features of the example embodiments. Thus, it is clear that the above-described example embodiments are illustrative in all aspects and do not limit the present disclosure. For example, each component described to be of a single type can be implemented in a distributed manner. Likewise, components described to be distributed can be implemented in a combined manner.

The scope of the inventive concept is defined by the following claims and their equivalents rather than by the detailed description of the example embodiments. It shall be understood that all modifications and embodiments conceived from the meaning and scope of the claims and their equivalents are included in the scope of the inventive concept.

We claim:

1. A handheld tachometer, comprising:
a body that controls light output, and calculates a velocity of an object based on incident light reflected from the object, and
a reflector that is positioned at a light output terminal of the body, to adjust an angle of output light or incident light.

2. The handheld tachometer of claim 1, further comprising
a light guide portion that is connected to the light output terminal of the body to guide the heading of output light or incident light,
wherein one side surface of the reflector is hinge-connected to one side surface of the light guide portion, such that a connection angle between the reflector and the light guide portion is adjustable.

3. The handheld tachometer of claim 1, further comprising
a light guide portion that is connected to the light output terminal of the body to guide the heading of output light or incident light, and
a step motor that is fixed to the light guide portion, and connected to the reflector, wherein driving of the step motor is controlled to adjust a connection angle between the reflector and the light guide portion.

4. The handheld tachometer of claim 3, further comprising
a motor control interface that is connected to one side surface of the body to control a driving direction and a driving degree of the step motor.

5. The handheld tachometer of claim 2,
wherein the reflector opens and covers an opening of the light guide portion according to the connection angle between the reflector and the light guide portion.

6. The handheld tachometer of claim 3,
wherein the reflector opens and covers an opening of the light guide portion according to the connection angle between the reflector and the light guide portion.

7. An optical instrument comprising:
a body that controls light output, and performs optical measurement based on incident light reflected from an object; and
a reflector that is positioned at a light output terminal of the body, to adjust an angle of output light or incident light.

8. The optical instrument of claim 7, further comprising
a light guide portion that is connected to the light output terminal of the body to guide the heading of output light of incident light,
wherein one side surface of the reflector is hinge-connected to one side surface of the light guide portion, such that a connection angle between the reflector and the light guide portion is adjustable.

9. The optical instrument of claim 7, further comprising
a light guide portion that is connected to the light output terminal of the body to guide the heading of output light or incident light, and
a step motor that is fixed to the light guide portion, and connected to the reflector, wherein driving of the step motor is controlled to adjust a connection angle between the reflector and the light guide portion.

10. The optical instrument of claim 9, further comprising
a motor control interface that is connected to one side surface of the body to control a driving direction and a driving degree of the step motor.

11. The handheld tachometer of claim 1, wherein the velocity is a rotational velocity.

12. The optical instrument of claim 9, wherein the velocity is a rotational velocity.
